(19) United States
(12) Patent Application Publication
(10) Pub. No.: US 2026/0255313 A1
(43) Pub. Date: Aug. 27, 2026

(54) WIRELESS COMMUNICATION METHOD AND TERMINAL DEVICE

(71) Applicant: GUANGDONG OPPO MOBILE TELECOMMUNICATIONS CORP., LTD., Dongguan (CN)

(72) Inventors: Yi HU, Dongguan (CN); Haitao LI, Dongguan (CN)

(21) Appl. No.: 19/651,254

(22) Filed: Apr. 17, 2026

Related U.S. Application Data
(63) Continuation of application No. PCT/CN2023/126485, filed on Oct. 25, 2023.

(51) Int. Cl. H04W 64/00; H04W 36/08; H04W 56/00; H04W 76/20; H04W 80/02; H04W 84/06

(52) U.S. Cl. CPC H04W 64/00; H04W 36/08; H04W 56/0045; H04W 76/20; H04W 80/02; H04W 84/06

(57) ABSTRACT

A wireless communication method and a terminal device are provided. The method includes the following. The terminal device executes a first operation in response to the terminal device initiating global navigation satellite system (GNSS) measurement, where the first operation includes one or more of: releasing a resource configured by a network device for the terminal device, and clearing or stopping using a dedicated offset parameter of the terminal device.

### CROSS-REFERENCE TO RELATED APPLICATION(S)

This application is a continuation of International Application No. PCT/CN2023/126485, filed Oct. 25, 2023, the entire disclosure of which is incorporated herein by reference.

### TECHNICAL FIELD

This disclosure relates to the field of communication technology, and particularly, to a wireless communication method and a terminal device.

### BACKGROUND

A terminal device can acquire information about its own position through global navigation satellite system (GNSS) measurement, yet executing GNSS measurement by the terminal device may bring about some issues. For example, during executing GNSS measurement, the terminal device is unable to communicate but still occupies dedicated transmission resources configured by a network for the terminal device, which is not conducive to efficient utilization of resources.

### SUMMARY

In a first aspect, a wireless communication method is provided. The method includes the following. A terminal device executes a first operation in response to the terminal device initiating global navigation satellite system (GNSS) measurement. The first operation includes one or more of: releasing a resource configured by a network device for the terminal device, and clearing or stopping using a dedicated offset parameter of the terminal device.

In a second aspect, a wireless communication method is provided. The method includes the following. A terminal device triggers reporting of a timing advance (TA) parameter when a second condition is met. The second condition is associated with one or more of: a time when the terminal device completes global navigation satellite system (GNSS) measurement, handover of a cell serving the terminal device, and handover of a satellite serving the terminal device.

In a third aspect, a terminal device is provided. The terminal device includes a memory and a processor, wherein the memory is configured to store a computer program, and the processor is configured to execute the computer program to cause the terminal device to execute a first operation, in response to the terminal device initiating global navigation satellite system (GNSS) measurement. The first operation includes one or more of: releasing a resource configured by a network device for the terminal device, and clearing or stopping using a dedicated offset parameter of the terminal device.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiments described herein.

### BRIEF DESCRIPTION OF THE DRAWINGS

FIG. 1A is a schematic diagram of a communication scenario to which embodiments of the disclosure may be applied.

FIG. 1B is a schematic diagram of another communication scenario to which embodiments of the disclosure may be applied.

FIG. 1C is a schematic diagram of yet another communication scenario to which embodiments of the disclosure may be applied.

FIG. 2 is a schematic diagram of yet another communication scenario to which embodiments of the disclosure may be applied.

FIG. 3 is a schematic diagram of yet another communication scenario to which embodiments of the disclosure may be applied.

FIG. 4 is a schematic diagram of yet another communication scenario to which embodiments of the disclosure may be applied.

FIG. 5A is a schematic diagram illustrating time delays for uplink (UL) signals to reach a network device.

FIG. 5B is another schematic diagram illustrating time delays for UL signals to reach a network device.

FIG. 6A is a schematic diagram illustrating a timing relationship in non-terrestrial network (NTN).

FIG. 6B is another schematic diagram illustrating a timing relationship in NTN.

FIG. 7 is a schematic flowchart of a wireless communication method provided in an embodiment of the disclosure.

FIG. 8 is a schematic flowchart of a wireless communication method provided in another embodiment of the disclosure.

FIG. 9 is a schematic structural diagram of a terminal device provided in an embodiment of the disclosure.

FIG. 10 is a schematic structural diagram of a terminal device provided in an embodiment of the disclosure.

FIG. 11 is a schematic structural diagram of an apparatus to which the embodiments of the disclosure may be applied.

### DETAILED DESCRIPTION

The technical solutions of the disclosure are described below with reference to the accompanying drawings.

### Communication System Architecture

The technical solutions of embodiments of the disclosure are applicable to various communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (Wi-Fi), the 5th-generation (5G) communication system, or other communication systems such as future communication systems like the sixth-generation (6G) mobile communication system, a satellite communication system, etc.

Generally speaking, a conventional communication system supports a limited quantity of connections and therefore is easy to implement. However, with development of communication technology, a mobile communication system will not only support conventional communication but also support, for example, device to device (D2D) communication, machine to machine (M2M) communication, machine type communication (MTC), vehicle to vehicle (V2V) communication, or vehicle to everything (V2X) communication, etc. The embodiments of the disclosure can also be applied to these communication systems.

The communication system in embodiments of the disclosure may be applied to a carrier aggregation (CA) scenario, or may be applied to a dual connectivity (DC) scenario, or may be applied to a standalone (SA) network deployment scenario.

The communication system in embodiments of the disclosure is applicable to an unlicensed spectrum, and an unlicensed spectrum may be regarded as a shared spectrum. Or the communication system in embodiments of the disclosure is applicable to a licensed spectrum, and a licensed spectrum may be regarded as a non-shared spectrum.

The embodiments of the disclosure can be applied to an NTN system, and can also be applied to a terrestrial network (TN) system. By way of explanation rather than limitation, the NTN system includes a NR-based NTN system and an internet of things (IoT)-based NTN system.

Various embodiments of the disclosure are described in connection with a network device and a terminal device. The terminal device may also be referred to as a user equipment (UE), an access terminal, a subscriber unit, a subscriber station, a mobile station (MS), a mobile terminal (MT), a remote station, a remote terminal, a mobile device, a user terminal, a terminal, a wireless communication device, a user agent, or a user device, etc.

The terminal device may be a station (ST) in a WLAN, a cellular radio telephone, a cordless telephone, a session initiation protocol (SIP) telephone, a wireless local loop (WLL) station, a personal digital assistant (PDA), a handheld device or a computing device with wireless communication functions, other processing devices coupled with a wireless modem, an in-vehicle device, a wearable device, and a terminal device in a next-generation communication system, for example, a terminal device in an NR network, or a terminal device in a future evolved public land mobile network (PLMN), etc.

In embodiments of the disclosure, the terminal device may be a device that provides voice and/or data connectivity to users, and may be used to connect people, objects, and machines, such as the handheld device with wireless connection functions, the in-vehicle device, etc. In embodiments of the disclosure, the terminal device may be a mobile phone, a pad, a laptop, a palmtop computer, a mobile internet device (MID), the wearable device, a virtual reality (VR) terminal device, an augmented reality (AR) terminal device, a wireless terminal device in industrial control, a wireless terminal device in self driving, a wireless terminal device in remote medicine, a wireless terminal device in smart grid, a wireless terminal device in transportation safety, a wireless terminal device in smart city, or a wireless terminal device in smart home, etc. Optionally, the terminal device may be used to serve as a base station. For example, the terminal device may serve as a scheduling entity that provides sidelink signals between terminal devices in scenarios such as V2X or D2D. For instance, the cellular radio telephone and a vehicle communicate with each other through sidelink signals, and the cellular radio telephone and a smart home device communicates with each other without relaying communication signals through the base station.

In embodiments of the disclosure, the terminal device may be deployed on land, which includes indoor or outdoor, handheld, wearable, or in-vehicle. The terminal device may also be deployed on water (such as ships, etc.). The terminal device may also be deployed in the air (such as airplanes, balloons, satellites, etc.).

In embodiments of the disclosure, the terminal device may be a mobile phone, a pad, a computer with wireless transceiver functions, the VR terminal device, the AR terminal device, the wireless terminal device in industrial control, the wireless terminal device in self driving, the wireless terminal device in remote medicine, the wireless terminal device in smart grid, the wireless terminal device in transportation safety, the wireless terminal device in smart city, or the wireless terminal device in smart home, etc. In embodiments of the disclosure, the terminal device may also be referred to as a terminal, a UE, an access terminal device, an in-vehicle terminal, an industrial control terminal, a UE unit, a UE station, the MS, a mobile platform, the remote station, the remote terminal, the mobile device, the wireless communication device, a UE agent, or a UE apparatus, etc. The terminal device may be fixed or mobile.

By way of explanation rather than limitation, in embodiments of the disclosure, the terminal device may also be the wearable device. The wearable device may also be referred to as a wearable smart device, which is a generic term of wearable devices obtained through intelligent design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. The wearable smart device in a broad sense may include, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

In embodiments of the disclosure, the network device may be a device configured to communicate with the terminal device, and the network device may be an access network device or a radio access network device, for example, the base station. In embodiments of the disclosure, the network device may refer to a radio access network (RAN) node (or device) that connects the terminal device to a wireless network. The base station can broadly cover or be replaced with the following various names, such as, a Node B (NB), an evolved Node B (eNB), a next generation NodeB (gNB), a relay station, an access point (AP), a transmitting and receiving point (TRP), a transmitting point (TP), a master eNB (MeNB), a secondary eNB (SeNB), a multi-standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), a positioning node, etc. The base station can be a macro base station, a micro base station, a relay node, a donor node, or the like, or a combination thereof. The base station can also be referred to as a communication module, a modem, or a chip configured in the aforementioned equipment or device. The base station can also be a mobile switching center, a device that performs base station functions in D2D communication, V2X communication, or M2M communication, a network-side device in a 6G network, a device that performs base station functions in future communication systems, etc. The base station can support networks using the same or different access technologies. Specific technology and specific device form adopted by the network device are not limited in embodiments of the disclosure.

The base station can be either fixed or mobile. For example, a helicopter or a drone can be configured to act as a mobile base station, and one or more cells can move according to a position of the mobile base station. In other examples, the helicopter or the drone can be configured to serve as a device that communicates with another base station.

In some deployments, the network device in embodiments of the disclosure may refer to the CU or the DU, or the network device includes the CU and the DU. The gNB may also include the AAU.

The network device and the terminal device may be deployed on land, which includes indoor or outdoor, handheld, wearable, or in-vehicle; or may also be deployed on water (such as ships, etc.); or may also be deployed on airplanes, balloons, satellites in the air. Scenarios in which the network device and the terminal device are located are not limited in embodiments of the disclosure.

By way of explanation rather than limitation, in embodiments of the disclosure, the network device may be mobile. For example, the network device may be the mobile device. Optionally, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station deployed on land or water.

In embodiments of the disclosure, the network device serves a cell, and the terminal device communicates with the network device on a transmission resource (for example, a frequency-domain resource or a spectrum resource) for the cell. The cell may be a cell corresponding to the network device (for example, a base station). The cell may belong to a macro base station, or may belong to a base station corresponding to a small cell. The small cell may include: a metro cell, a micro cell, a pico cell, a femto cell, and the like. These small cells are characterized by small coverage and low transmission power and are adapted to provide data transmission service with high-rate.

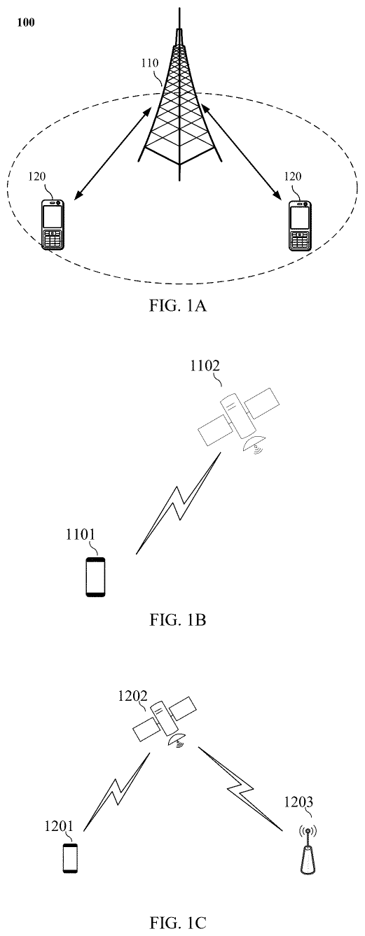

Exemplarily, FIG. 1A is a schematic architectural diagram of a communication system provided in embodiments of the disclosure. As illustrated in FIG. 1A, a communication system 100 may include a network device 110. The network device 110 may be a device for communicating with a terminal device 120 (also referred to as “communication terminal” or “terminal”). The network device 110 can provide a communication coverage for a specific geographical area and communicate with terminal devices in the coverage area.

FIG. 1A exemplarily illustrates one network device and two terminal devices. In some embodiments of the disclosure, the communication system 100 may include multiple network devices, and there can be other quantities of terminal devices in a coverage area of each of the network devices. The embodiments of the disclosure are not limited in this regard.

Exemplarily, FIG. 1B is a schematic architectural diagram of another communication system provided in embodiments of the disclosure. Referring to FIG. 1B, the communication system includes a terminal device 1101 and a satellite 1102. Wireless communication can be performed between the terminal device 1101 and the satellite 1102. The network formed between the terminal device 1101 and the satellite 1102 can be referred to as NTN. In the communication system architecture illustrated in FIG. 1B, the satellite 1102 may have the functions of the base station, therefore direct communication can be carried out between the terminal device 1101 and the satellite 1102. In the system architecture, the satellite 1102 can be referred to as the network device. In some embodiments of the disclosure, the communication system may include multiple network devices 1102, and there can be other quantities of terminal devices in a coverage area of each of the network devices 1102. The embodiments of the disclosure are not limited in this regard.

Exemplarily, FIG. 1C is a schematic architectural diagram of another communication system provided in embodiments of the disclosure. Referring to FIG. 1C, the communication system includes a terminal device 1201, a satellite 1202, and a base station 1203. Wireless communication can be performed between the terminal device 1201 and the satellite 1202, and communication can be performed between the satellite 1202 and the base station 1203. The network formed among the terminal device 1201, the satellite 1202, and the base station 1203 can be referred to as NTN. In the communication system architecture illustrated in FIG. 1C, the satellite 1202 may not have the functions of the base station, and communication between the terminal device 1201 and the base station 1203 needs to be relayed through the satellite 1202. In the system architecture, the base station 1203 can be referred to as the network device. In some embodiments of the disclosure, the communication system may include multiple network devices 1203, and there can be other quantities of terminal devices in a coverage area of each of the network devices 1203. The embodiments of the disclosure are not limited in this regard.

It may be noted that FIG. 1A to FIG. 1C merely illustrate the systems applicable to the disclosure by way of explanation. Apparently, the methods illustrated in embodiments of the disclosure can also be applicable to other systems, such as the 5G communication system, the LTE communication system, etc. The embodiments of the disclosure are not specifically limited in this regard.

In some embodiments of the disclosure, the wireless communication systems illustrated in FIG. 1A to FIG. 1C may further include other network entities such as a mobility management entity (MME), an access and mobility management function (AMF), etc., which are not limited in embodiments of the disclosure.

It can be understood that, in embodiments of the disclosure, a device with communication functions in a network/system can be referred to as a “communication device”. Taking the communication system 100 illustrated in FIG. 1A as an example, the communication device may include the network device 110 and the terminal device(s) 120 that have communication functions. The network device 110 and the terminal device(s) 120 can specifically be the aforementioned devices, which will not be repeated again herein. The communication device may further include other devices such as a network controller, the MME, or other network entities in the communication system 100. The embodiments of the disclosure are not limited in this regard.

It can be understood that, “indication” referred to in embodiments of the disclosure may be a direct indication, may be an indirect indication, or may mean that there is an association relationship. For example, A indicates B may mean that A directly indicates B, for instance, B can be obtained according to A; may mean that A indirectly indicates B, for instance, A indicates C, and B can be obtained according to C; or may mean that that there is an association relationship between A and B.

In the elaboration of embodiments of the disclosure, the term “correspondence” may mean that there is a direct or indirect correspondence between the two, may mean that there is an association between the two, or may mean a relationship of indicating and indicated or configuring and configured, etc.

In embodiments of the disclosure, the “configuration” may be configured through at least one of a system message, a radio resource control (RRC) signaling, or a medium access control-control element (MAC CE).

In embodiments of the disclosure, the “pre-defined” or the “pre-set” can be implemented by pre-saving a corresponding code or table in a device (for example, including the terminal device and the network device) or in other manners that can be used for indicating related information, and the disclosure is not limited in this regard. For example, the “pre-defined” may mean defined in a protocol.

In embodiments of the disclosure, the “protocol” may refer to a communication standard protocol, which may include, for example, an LTE protocol, an NR protocol, and a protocol applied to a future communication system, and the disclosure is not limited in this regard.

### Non-Terrestrial Network (NTN)

Currently, the 3rd generation partnership project (3GPP) is studying non-terrestrial network (NTN) technology. NTN generally provides communication services to terrestrial users through satellite communication. Compared with terrestrial cellular network communication, satellite communication has many unique advantages.

First, satellite communication is not constrained by areas of users. For example, terrestrial communication is unable to cover areas where communication devices cannot be set up, such as oceans, mountains, and deserts; as well as areas without communication coverage like sparsely populated areas. In contrast, for satellite communication, one satellite can cover a large ground and the satellite can orbit the earth. Therefore, in theory, every corner on the earth can be covered for satellite communication.

Second, satellite communication has greater social value. Remote mountainous areas and poverty-stricken and underdeveloped countries or regions can be covered for satellite communication at a low cost, so that people in these areas can enjoy advanced voice communication and mobile internet technologies, thereby narrowing a digital gap with developed areas and thus promoting development of these areas.

Third, a satellite has an advantage of supporting communication with long communication distance, and increase in communication distance will not lead to substantial increase in communication cost.

Finally, satellite communication has high stability and is not constrained by natural disasters.

Communication satellites are classified into low-earth orbit (LEO) satellites, medium-earth orbit (MEO) satellites, geostationary earth orbit (GEO) satellites, high elliptical orbit (HEO) satellites, and the like according to different orbital altitudes. At the current stage, the research mainly focuses on LEO satellites and GEO satellites.

For the LEO satellite, the orbital altitude thereof ranges from 500 km (kilometer) to 1500 km, an orbital period is about 1.5 hours to 2 hours, and a signal propagation delay of single-hop communication between users is generally less than 20 ms (millisecond). A satellite has a maximum visibility time of 20 minutes, a short signal propagation distance, and a less link loss, and does not have high requirements on transmission power for the terminal device.

For the GEO satellite, the orbital altitude thereof is 35786 km, an orbital period is 24 hours, and a signal propagation delay of single-hop communication between users is generally 250 ms.

In order to ensure the coverage of the satellite and increase the system capacity of the entire satellite communication system, the satellite uses multi-beams to cover the ground. One satellite can provide tens of or even hundreds of beams for ground coverage, and one satellite beam can cover a ground area with a diameter of tens to hundreds of kilometers.

Currently, the NTN system includes the NR-NTN system and the IoT-NTN system.

Currently, 3GPP takes two types of satellites into discussion. One is a satellite with transparent payload, and the other is a satellite with regenerative payload. With reference to FIG. 2 to FIG. 4, a network architecture of the satellite with transparent payload and a network architecture of the satellite with regenerative payload will be introduced respectively below.

Satellite network architectures illustrated in FIG. 2 to FIG. 4 may include a terminal device 210, a satellite node 222, and a ground receiving station 221 (referred to as “ground station” for short). Wireless communication can be performed between the terminal device 210 and the satellite node 222. The terminal device 210 can send data to the satellite node 222 via a link between the terminal device 210 and the satellite node 222. For example, the data can be sent to the satellite node 222 via a service link. Correspondingly, after receiving the data, the satellite node 222 can send the received data to the ground receiving station 221 via a link between the satellite node 222 and the ground receiving station 221. For example, the data can be sent to the ground receiving station 221 via a wireless link (such as a feeder link). Correspondingly, after receiving the data from the satellite node 222, the ground receiving station 221 transmits the data to a core network (data network). Then, the core network processes the data, such as interacting the data with other terminals, etc. It can be understood that the service link herein refers to the link between the terminal device 210 and the satellite node 222, and the feeder link refers to the link between the satellite node 222 and the ground receiving station 221. In other possible embodiments, the link between the terminal device and the satellite node and/or the link between the satellite node and the ground receiving station may further be expressed by other terms, which is not limited in the disclosure.

The types of the aforementioned satellite node 222 can be classified into three categories. The first type of satellite node is only used for forwarding, that is, this type of satellite node only has functions for transparent payload. In some implementations, this type of satellite node can provide one or more of the following functions: radio frequency filtering, frequency conversion, or power amplification. As illustrated in FIG. 2, this type of satellite node amplifies the received signal from the terminal device and then sends the amplified terminal device signal to the ground receiving station without any processing at the satellite node. The terminal device and the satellite node can communicate via an NR-Uu interface. The satellite node and the ground receiving station (which may include an NTN remote radio unit (RRU) and the gNB) can communicate via the NR-Uu interface. The ground receiving station and the 5G core network (5G CN) can communicate via N1/N2/N3 interface. The 5G CN and the data network can communicate via N6 interface.

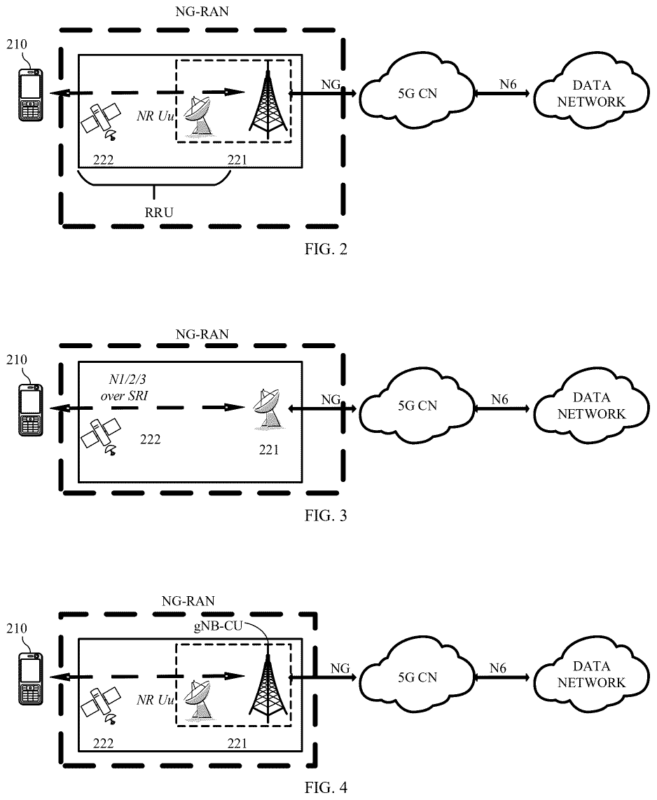

The second type of satellite node has complete processing functions of the base station. For the ground terminal device, the satellite node serves as a base station. As illustrated in FIG. 3, communication between the satellite node and the terminal device is basically the same as the normal 5G communication. In some implementations, this type of satellite node can further provide one or more of the following functions: demodulation, decoding, routing, switching, coding, or modulation. The terminal device and the satellite node can communicate via the NR-Uu interface. The satellite node and the ground receiving station can communicate via a satellite radio interface (SRI), and interface messages (such as an N2/N3 interface message) between the satellite node and the 5G CN can be sent via the SRI interface. The ground receiving station and the 5G CN can communicate via N1/N2/N3 interface. The 5G CN and the data network can communicate via N6 interface.

The third type of satellite node has processing functions of the DU. For the ground terminal device, the satellite node serves as the DU. As illustrated in FIG. 4, communication between the satellite node and the terminal device is basically the same as communication between the terminal device and the DU in a normal 5G terrestrial communication system. The terminal device and the satellite node can communicate via the NR-Uu interface. The satellite node and the ground receiving station (which may include a gNB-CU) can communicate via the SRI interface, and an F1 interface message between the satellite and the ground receiving station can be transmitted via the SRI interface. The ground receiving station and the 5G CN can communicate through the N1/N2/N3 interface. The 5G CN and the data network can communicate through the N6 interface.

### Timing Advance (TA)

Wireless communication system (for example, an LTE/NR system) can adopt an orthogonal frequency division multiplexing (OFDM) transmission scheme, since the wireless communication system can have good demodulation performance solely when subcarriers maintain orthogonality to one another. However, due to propagation delay, downlink (DL) signals are delayed for a certain time before being received by a terminal device. Since different terminal devices are located at different positions relative to a network device, uplink (UL) signals sent by different terminal devices may reach the network device at different time, which may seriously affect orthogonality among subcarriers and reduce demodulation performance of the OFDM transmission scheme.

Taking uplink transmission as an example, an important feature of uplink transmission is orthogonal multiple access of different terminal devices in time-frequency domain, that is, uplink transmissions from different terminal devices within the same cell do not interfere with each other. Uplink transmissions are generally transmissions by multiple terminal devices; as a result, the network device may receive signals from multiple terminal devices simultaneously.

To ensure orthogonality of uplink transmissions and avoid intra-cell interference, the network device requires that, signals from different terminal devices using different frequency-domain resources at the same time reach the network device at a basically aligned time, this is because the network device can correctly decode uplink data as long as the network device receives the uplink data sent by the terminal device within a cyclic prefix range. In addition, to ensure orthogonality among uplink reference signals with different cyclic shifts, the network device further requires that the uplink reference signals are received at an aligned time. Therefore, to achieve uplink synchronization, or in other words, to ensure timing alignment at the network device side, the wireless communication system (for example, the LTE/NR system) supports uplink timing advance (TA) mechanism.

TA can be understood as a command sent by a network device to a terminal device to adjust the uplink transmission of the terminal device. The uplink transmission of the terminal device is not limited in embodiments of the disclosure. For example, the uplink transmission may include one or more of: physical uplink shared channel (PUSCH), physical uplink control channel (PUCCH), sounding reference signal (SRS), etc.

In a communication system that supports uplink TA, an uplink clock and a downlink clock at the network device side are aligned, while there is an offset between the uplink clock and the downlink clock at a terminal device side, and different terminal devices have different uplink TA values. For the terminal device side, the TA value is essentially an offset between a starting time of receiving a downlink frame by the terminal device and a time of transmitting the uplink frame by the terminal device. By appropriately controlling the offset at each terminal device, the network device can control the time at which uplink signals from different terminal devices reach the network device to be basically aligned. A terminal device far away from the network device needs to send uplink data earlier than a terminal device closer to the network device due to larger propagation delay.

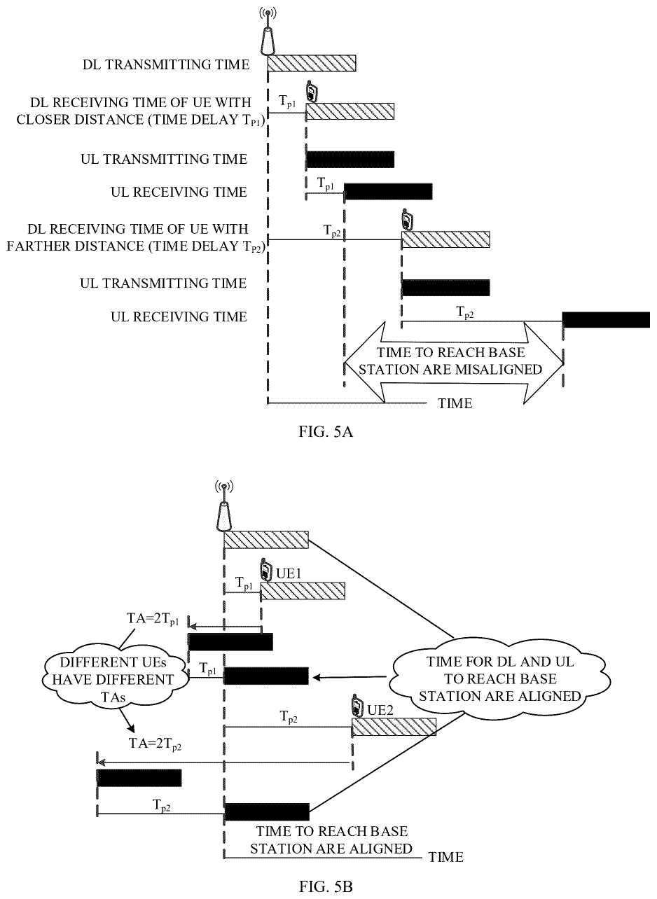

FIG. 5A and FIG. 5B respectively illustrate time delays for uplink signals to reach the network device without TA and time delays for uplink signals to reach the network device with TA. As illustrated in FIG. 5A, without TA, uplink signals sent by different terminal devices (for example, terminal devices at different distances from the network device) reach the network device at different time, which may cause intra-cell interference. While after introducing TA, as illustrated in FIG. 5B, different terminal devices are configured with different uplink TAs, so that uplink signals sent by different terminal devices reach the network device at an aligned time, which helps to avoid intra-cell interference. Taking an example where the different terminal devices illustrated in FIG. 5B are regarded as terminal device 1 and terminal device 2, if terminal device 1 and terminal device 2 keep synchronization in receiving downlink signals and sending uplink signals, the uplink signal sent by terminal device 1 will have an offset of 2Tₚ₁ from the network device, and the uplink signal sent by terminal device 2 will have an offset of 2Tₚ₂ from the network device, thereby ensuring that the uplink signals from terminal device 1 and terminal device 2 reach the network device at an aligned time. In other words, if terminal device 1 and terminal device 2 keep synchronization in receiving downlink signals and sending uplink signals, then the TA value corresponding to terminal device 1 is 2Tₚ₁, and the TA value corresponding to terminal device 2 is 2Tₚ₂, thereby ensuring that the uplink signals from terminal device 1 and terminal device 2 reach the network device at the same time.

The network device can determine the TA value for each terminal device by measuring the uplink transmission of the terminal device. The network device can send a TA command to the terminal device to inform a corresponding TA value to the terminal device. For example, the network device can send the TA command to the terminal device in two manners as follows.

Manner 1: Acquisition of initial TA. The terminal device can achieve initial uplink synchronization through a random access procedure. During the random access procedure, the network device can determine the TA value by measuring a received preamble and send the TA value to the terminal device via a timing advance command (TAC) field in a random access response (RAR) message. For example, the network device can carry a 12-bit TAC in the RAR message to indicate to the terminal device the initial TA.

Method 2: TA refinement in RRC_CONNECTED. Although the terminal device and the network device has achieved uplink synchronization during the random access procedure, the timing for the uplink signal to reach the network device may change over time. Therefore, the terminal device needs to continuously update its uplink TA value to maintain uplink synchronization. If the TA of the terminal device needs to be rectified, the network device can send the TA command to the terminal device and require the terminal device to refine the uplink timing. In some implementations, the network device sends the TA command to the terminal device via a MAC CE, and this type of MAC CE can also be referred to as a TA command MAC CE (i.e., a MAC CE carrying the TA command). That is to say, when the terminal device is in an RRC_CONNECTED state, the terminal device can refine the uplink transmission via the MAC CE carrying the TA command.

In a CA scenario, the terminal device may need to use different TAs for different uplink carriers. Therefore, the protocol introduces a concept of timing advance group (TAG). The network device can configure a maximum of 4 TAGs for each cell group of the terminal device, and configure for each serving cell a TAG associated with the serving cell. In some implementations, the terminal device can separately maintain the TA for each TAG.

In traditional TN networks, the UE can perform TA maintenance based on the TA command issued by the network. For NTN in Rel-17, assuming that the UE has GNSS positioning capability and TA pre-compensation capability, then the UE can independently estimate a TA of the service link based on a position of the UE and a position of the serving satellite. Therefore, a TA determination method combining open-loop and closed-loop is introduced into the NTN. Based on the current R17 protocol, for an NTN UE in an RRC_IDLE state/RRC_INACTIVE state or the RRC_CONNECTED state, the TA is determined by the following formula:

$${T}_{TA} = ( {N}_{TA} + {N}_{TA , UE - specific} + {N}_{TA , common} + {N}_{TA , offset} ) \times {T}_{c}$$

N_{TA} is defined as 0 regarding a scenario for PRACH transmission, and N_{TA} can be updated later through a TA command and a TA command MAC CE carried in Msg2/MsgB.

N_{TA,UE-specific} is a TA of the service link estimated by the UE itself and is used for TA pre-compensation. Specifically, the terminal acquires a position of the satellite according to acquired GNSS position information in combination with satellite ephemeris information broadcast by the serving cell, thereby calculating the propagation delay of the service link from the UE to the satellite.

N_{TA,common} is a common TA controlled by the network, and the N_{TA,common} includes any timing deviation deemed necessary by the network.

N_{TA,offset} is a fixed offset used for calculating the TA.

As can be seen from the above TA calculation formula, for the UE in the RRC_CONNECTED state to acquire the service link TA (i.e., N_{TA,UE-specific}), the UE needs to acquire its own GNSS position information, and further needs to acquire the position of the serving satellite through satellite ephemeris information of the serving cell. In addition, to calculate the TA of the UE, the UE further needs to acquire the common TA (i.e., N_{TA,common}).

### Timing Relationship in NTN System

In terrestrial mobile systems, the propagation delays of signal communication are usually less than 1 ms. In the NTN system, with long communication distance between terminal devices and satellites (or network devices), the propagation delay of signal communication is much longer. For example, the propagation delay can range from tens milliseconds to hundreds of milliseconds, depending on the satellite orbit altitude and the type of satellite communication service. To handle the aforementioned large propagation delay, the timing relationship in the NTN system needs to be enhanced compared with the NR system.

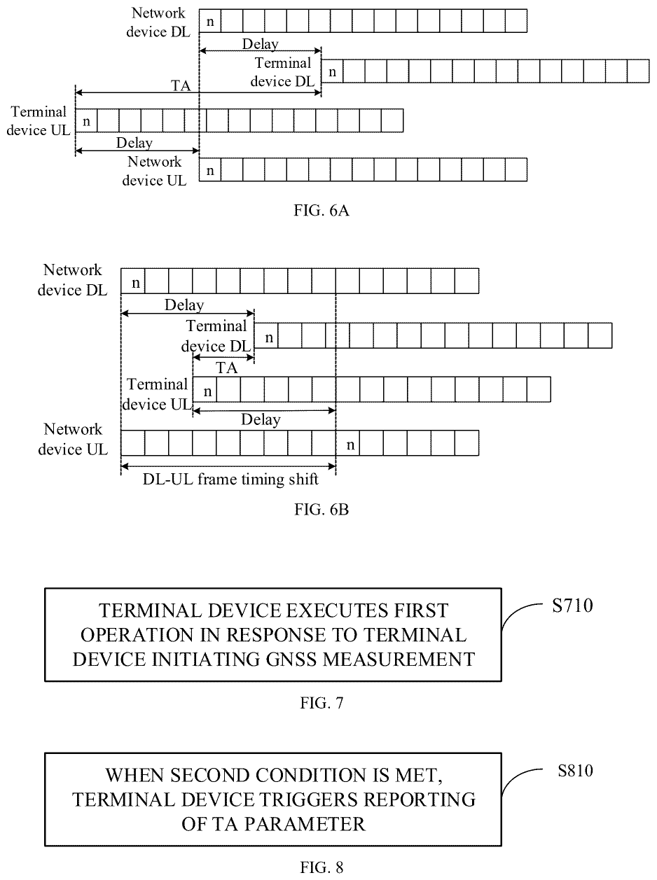

Similar to the NR system, in the NTN system, the terminal device needs to consider the impact of TA during uplink transmission. Due to large propagation delay in the NTN system, the range of the TA value is relatively large. When the terminal device is scheduled for uplink transmission in a slot n, the terminal device can determine an uplink transmission opportunity (such as advancing the time for uplink transmission) based on round-trip propagation delay, so that the signal reaches a base station side in an uplink slot n at the base station side. The timing relationships in the NTN system can include two cases, as illustrated in FIG. 6A and FIG. 6B respectively.

In one case, similar to the NR system, a downlink slot and an uplink slot are aligned at the base station side in the NTN system (such as a slot n illustrated in FIG. 6A). In this case, in order to align the uplink transmission of the terminal device with the uplink slot and the downlink slot at the base station side, the terminal device needs a greater TA value. During uplink transmission, a greater offset value, such as K_{offset}, is also needed to be introduced.

In another case, different from the NR system, an offset value exists between the downlink slot and uplink slot at the base station side (such as an uplink and downlink frame timing offset illustrated in FIG. 6B). In this case, if it is desired to align the uplink transmission of the terminal device with the uplink slot at the base station side, the terminal device needs a smaller TA value. However, in this case, additional complexity is needed at the base station to manage corresponding scheduling timing.

### Timing Relationship in NR System

To ensure communication quality, relevant technologies define timing relationships in the NR system. The following will respectively introduces physical downlink shared channel (PDSCH) reception timing, PUSCH transmission timing, hybrid automatic repeat request-acknowledgement (HARQ-ACK) transmission timing, MAC CE action timing, channel state information (CSI) transmission timing, CSI reference resource timing, and aperiodic SRS transmission timing.

PDSCH reception timing: When a UE is scheduled to receive PDSCH by downlink control information (DCI), the DCI includes indication information of K₀, where K₀ is used to determine a slot for transmitting the PDSCH. For example, if the scheduling DCI is received in a slot n, the slot allocated for the PDSCH is

$$⌊ n \cdot \frac{{2}^{{μ}_{PDSCH}}}{{2}^{{μ}_{PDCCH}}} ⌋ + {K}_{0} ,$$

where K₀ is determined based on a subcarrier spacing of the PDSCH, and μ_{PDSCH} and μ_{PDSCH} are subcarrier spacing configurations for PDSCH and PDCCH, respectively. The value of K₀ ranges from 0 to 32.

Transmission timing for PUSCH scheduled by DCI: When a UE is scheduled to transmit PUSCH by a DCI, the DCI includes indication information of K₂, where K₂ is used to determine a slot for transmitting the PUSCH. For example, if the scheduling DCI is received in a slot n, the slot allocated for the PUSCH is

$$⌊ n \cdot \frac{{2}^{{μ}_{PUSCH}}}{{2}^{{μ}_{PDCCH}}} ⌋ + {K}_{2} ,$$

where K₂ is determined based on a subcarrier spacing of the PUSCH, and μPUSCH and μPDCCH are subcarrier spacing configurations for PUSCH and PDCCH, respectively. The value of K₂ ranges from 0 to 32.

Transmission timing for PUSCH scheduled by RAR grant: With reference to a slot for PUSCH transmission scheduled by RAR UL grant, if the UE receives a PDSCH with a RAR message ending in slot n for a corresponding PRACH transmission from the UE, the UE transmits the PUSCH in slot n+K₂+Δ, where K₂ and Δ are provided in protocol.

Transmission timing for HARQ-ACK on PUCCH: With reference to slots for PUCCH transmissions, for a PDSCH reception ending in slot n or a semi-persistent scheduling (SPS) PDSCH release through a PDCCH reception ending in slot n, the UE provides corresponding HARQ-ACK information in a PUCCH transmission within slot n+K₁, where K₁ is a number of slots and is indicated by a PDSCH-to-HARQ-timing-indicator field in a DCI format, or provided by dl-DataToUL-ACK parameter. K₁=0 corresponds to the last slot of the PUCCH transmission that overlaps with the PDSCH reception or with the PDCCH reception in case of SPS PDSCH release.

MAC CE action timing: When a HARQ-ACK corresponding to a PDSCH carrying a MAC-CE command is transmitted in slot n, a corresponding action and a UE assumption on the downlink configuration indicated by the MAC-CE command shall be applied starting from the first slot that is after slot

$$n + 3 {N}_{slot}^{subframe , μ} , where {N}_{slot}^{subframe , μ}$$

denotes the number of slots per subframe for subcarrier spacing configuration μ.

Transmission timing for CSI on PUSCH: The transmission timing for CSI on PUSCH follows a general transmission timing for DCI scheduled PUSCH.

CSI reference resource timing: A CSI reference resource for a CSI report in uplink slot n′ is defined by a single downlink slot n−n_{CSI_ref}, where

$$n = ⌊ {n}^{′} \cdot \frac{{2}^{{μ}_{DL}}}{{2}^{{μ}_{UL}}} ⌋ ,$$

and μDL and μUL are subcarrier spacing configurations for DL and UL, respectively. The value of n_{CSI_ref} depends on the type of CSI report.

Aperiodic SRS transmission timing: If a UE receives a DCI triggering aperiodic SRS in slot n, the UE transmits aperiodic SRS in each of the triggered SRS resource set(s) in slot

$$⌊ n \cdot {2}^{\frac{{{μ}_{SRS}}^{}}{{{μ}_{PDCCH}}^{}}} ⌋ + k ,$$

where k is configured via higher layer parameter slotOffset for each triggered SRS resources set and is determined based on a subcarrier spacing of the triggered SRS transmission, and μ_{SRS} and μ_{PDCCH} are subcarrier spacing configurations for triggered SRS and PDCCH carrying the triggering command respectively.

### Timing Enhancement in NTN System

The PDSCH reception timing is defined solely from downlink (DL) timing perspective. It is not impacted by the large round-trip propagation delay in the NTN system. Therefore, the NTN system can reuse the PDSCH reception timing in the NR system.

In order to function properly in the NTN system, or in other words, to overcome the large propagation delay in the NTN system, the other timing relationships affected by DL-UL timing interaction need to be enhanced for NTN. One simple solution for the enhancement can be introducing an offset parameter K_{offset} into the system and applying the offset parameter to modify the relevant timing relationships. The following will introduce the usage of the offset parameter.

Transmission timing of DCI scheduled PUSCH (including CSI on PUSCH): If the scheduling DCI is received in slot n, the slot allocated for the PUSCH is

$$⌊ n \cdot \frac{{2}^{{μ}_{PUSCH}}}{{2}^{{μ}_{PDCCH}}} ⌋ + {K}_{2} + {K}_{offset} .$$

Transmission timing of RAR grant scheduled PUSCH: With reference to the slot for PUSCH transmission scheduled by RAR grant, the UE transmits the PUSCH in slot n+K₂+Δ+K_{offset}.

Transmission timing of HARQ-ACK on PUCCH: With reference to the slot for PUCCH transmission, the UE transmits corresponding HARQ-ACK information on a PUCCH resource in slot n+K₁+K_{offset}.

MAC CE action timing: When the HARQ-ACK corresponding to the PDSCH carrying the MAC-CE command is transmitted in slot n, the corresponding action and the UE assumption on the downlink configuration indicated by the MAC-CE command shall be applied starting from the first slot that is after slot

$$n + {XN}_{slot}^{subframe , μ} + {K}_{offset} ,$$

where the value of X may depend on NTN UE capability and may not necessarily be equal to 3.

CSI reference resource timing: The CSI reference resource for a CSI report in uplink slot n′ is defined by a single downlink slot n−n_{CSI}_{_{ref}}−K_{offset}.

Aperiodic SRS transmission timing: If a UE receives a DCI triggering aperiodic SRS in slot n, the UE transmits aperiodic SRS in each of the triggered SRS resource set(s) in slot

$$⌊ n \cdot {2}^{\frac{{{μ}_{SRS}}^{}}{{{μ}_{PDCCH}}^{}}} ⌋ + k + {K}_{offset} .$$

A cell specific K_{offset}, that is, K_{cell,offset}, can be broadcasted through system information of a cell in NTN. In addition, for the UE in the RRC_CONNECTED state, the network device can usually send a UE-dedicated offset parameter, that is, K_{UE,offset}, carried in Differential K_{offset} MAC CE to the UE based on the TA reported by the UE. K_{UE,offset} can be used to indicate the difference between the offset parameter used by the UE and the cell specific K_{offset}. That is to say, the K_{offset} used by the UE is K_{offset}=K_{cell,offset}−K_{UE,offset}. For example, for PUSCH transmission scheduled by PDCCH with a cell radio network temporary identifier (C-RNTI), K_{offset} is used to determine the transmission timing for PUSCH. In some other cases, such as PUSCH transmission scheduled by RAR UL grant, K_{cell,offset} can be used to determine the transmission timing for PUSCH.

### Global Navigation Satellite System (GNSS)

In R17, for an IoT NTN scenario, such as a scenario where narrowband internet of things (NB-IoT) and enhanced machine type communication (eMTC) access NTN, simultaneous GNSS and NTN NB-IoT/eMTC operation is not assumed. In R17 NTN, the IoT terminal device can perform GNSS measurement to acquire location information solely in the RRC_IDLE state or in the RRC_INACTIVE state, and cannot activate the GNSS module in the RRC_CONNECTED state. Therefore, before entering the RRC_CONNECTED state, the UE needs to first acquire a GNSS position of the UE through measurement by the GNSS module. The UE can determine a validity duration of the GNSS position according to a situation of the UE (such as a moving state of the UE), and report a remaining validity duration of the GNSS position to the network device during RRC connection establishment/RRC re-establishment/RRC connection recovery. For the UE in the RRC_CONNECTED state, when its validity duration of the GNSS position expires, the UE needs to return to the RRC_IDLE state since the UE cannot calculate the TA due to inability of performing GNSS operations in the RRC_CONNECTED state.

In R18, enhancements have been made to GNSS in a NTN scenario. For example, relevant meetings clearly put forward the following research objectives: to enhance the performance of IoT-NTN in R18 to address the issues left over from R17. This work considers Rel-17 IoT-NTN as baseline as well as Rel-17 NR-NTN outcome and the further IoT-NTN performance enhancements objectives are listed below.
Disabling of HARQ feedback to mitigate impact of HARQ stalling on UE data rates [RAN1, RAN2].
Study and specify, if needed, improved GNSS operations for a new position fix for UE pre-compensation during long connection times and for reduced power consumption [RAN1].

Based on the above research objectives, in R18, an IoT terminal device accessed to NTN will be able to execute GNSS measurement in the RRC_CONNECTED state. For GNSS measurement in the RRC_CONNECTED state, two triggering mechanisms of, GNSS measurement triggered by the network device and GNSS measurement autonomously triggered by terminal device, are supported.

For the GNSS measurement triggered by the network device, the network device will configure a duration of a GNSS measurement gap for the terminal device and trigger the terminal device to execute GNSS measurement by sending an MAC CE of the GNSS measurement. After receiving the MAC CE of the GNSS measurement, the terminal device starts the GNSS measurement gap and executes GNSS measurement during the GNSS measurement gap to acquire a GNSS position of the terminal device.

For the GNSS measurement autonomously triggered by the terminal device, the network device configures a GNSS measurement timer for the terminal device. The terminal device activates the GNSS measurement timer when a GNSS validity duration expires, or activates the GNSS measurement timer after a time duration X following expiration of the GNSS validity duration (where X is a time duration during which the terminal device is allowed to use an expired GNSS position for time-frequency pre-compensation for uplink transmission, after expiration of the GNSS validity duration of the terminal device). Then, the terminal device executes GNSS measurement during the running of the GNSS measurement timer to acquire the GNSS position of the terminal device.

However, performing GNSS operations by the terminal device in the RRC_CONNECTED state may bring some issues. As mentioned above, during executing GNSS measurement, the terminal device is unable to communicate with the network device (that is, the terminal device is unable to receive downlink transmissions or send uplink transmissions). The duration of the GNSS measurement gap or the GNSS measurement timer may have the following values: 1 s, 2 s, 3 s, 4 s, 5 s, 6 s, 7 s, 13 s, 19 s, 25 s, 31 s. As can be seen, the time used for GNSS measurement is relatively long, and during the GNSS measurement, the terminal device still occupies some dedicated transmission resources configured by the network device for the terminal device. From the perspective of system resource usage efficiency, this method is not conducive to efficient utilization of the system resource. In addition, after the terminal device completes the GNSS measurement, the TA of the terminal device may witness a significant change, which may result a previous dedicated offset parameter of the terminal device, Koffset, configured by the network device unavailable (for example, the TA of the terminal device is greater than the dedicated offset parameter of the terminal device), thereby affecting uplink transmission.

A wireless communication method is provided in embodiments of the disclosure. When a terminal device executes GNSS measurement, a resource configured by a network device for the terminal device is released and/or using a dedicated offset parameter of the terminal device is stopped (i.e., executing a first operation), so as to solve the above problem.

FIG. 7 is a schematic flow diagram of a wireless communication method provided in an embodiment of the disclosure. The wireless communication method provided in the embodiment of the disclosure will be introduced below with reference to FIG. 7. The method illustrated in FIG. 7 may be applicable to any of the aforementioned communication scenarios. For example, the method illustrated in FIG. 7 may be applicable to an NTN network communication scenario, such as a scenario where NB-IoT and eMTC access NTN.

Reference can be made to FIG. 7. In step S710, the terminal device executes the first operation in response to the terminal device initiating GNSS measurement.

In some embodiments, the aforementioned first operation may include releasing the resource configured by the network device for the terminal device. Since the terminal device is usually unable to communicate during executing GNSS measurement, the terminal device executes the first operation in response to the terminal device initiating GNSS measurement, which can help improve resource utilization.

In some embodiments, releasing the resource configured by the network device for the terminal device includes one or more of: clearing a hybrid automatic repeat request (HARQ) buffer of the terminal device; releasing a physical uplink control channel (PUCCH) resource of the terminal device; releasing a sounding reference signal (SRS) resource of the terminal device; releasing a dedicated resource of the terminal device for scheduling request (SR); releasing an uplink semi-persistent scheduling (SPS) resource of the terminal device; and releasing a downlink SPS resource of the terminal device.

In embodiments of the disclosure, by releasing the semi-static resource configured by the network when the terminal device initiates GNSS measurement, effective recovery of the semi-static resource can be realized. At the same time, the network device can configure the recovered resource to other terminal devices for usage, thereby helping to improve utilization efficiency of system resources.

In some embodiments, the aforementioned first operation may include clearing or stopping using the dedicated offset parameter of the terminal device. The dedicated offset parameter of the terminal device may be a dedicated offset parameter of the terminal device indicated by the network device and received by the terminal device before initiating GNSS.

The dedicated offset parameter of the terminal device can be used to determine an uplink transmission timing of the terminal device or a time-domain resource for uplink transmission of the terminal device. After the terminal device completes the GNSS measurement, a TA of the terminal device may witness a significant change. The change in the TA of the terminal device may result the dedicated offset parameter of the terminal device configured by the network device (e.g., configured by the network device for the terminal device before initiating the GNSS measurement) unavailable. For example, the TA of the terminal device is greater than the dedicated offset parameter of the terminal device.

Therefore, the first operation includes clearing or stopping using the dedicated offset parameter of the terminal device, which can avoid the impact on the uplink communication caused by an excessively small dedicated offset parameter of the terminal device.

In some embodiments, an offset parameter for uplink transmission of the terminal device is associated with a cell specific offset parameter and the dedicated offset parameter of the terminal device. Taking the aforementioned NTN scenario as an example, the offset parameter for uplink transmission of the terminal device may be a difference between the cell specific offset parameter and the dedicated offset parameter of the terminal device, that is, K_{offset}=K_{cell,offset}−K_{UE,offset}, where K_{cell,offset} is the cell specific offset parameter and K_{UE,offset} is the dedicated offset parameter of the terminal device. The aforementioned clearing or stopping using the dedicated offset parameter of the terminal device may mean that the offset parameter for uplink transmission of the terminal device is the cell specific offset parameter, or that the dedicated offset parameter of the terminal device is considered as “0” during calculating the offset parameter for uplink transmission of the terminal device, that is, K_{offset}=K_{cell,offset}.

The aforementioned stopping using can further be replaced by one or more of the following operations: ignoring, deleting, clearing, suspending, terminating using, and setting or resetting the value of the dedicated offset parameter as 0, etc.

In embodiments of the disclosure, by stopping using the dedicated offset parameter of the terminal device when the terminal device executes GNSS measurement, a previous dedicated offset parameter of the terminal device configured by the network device can be effectively avoided from being unavailable caused by a possible significant change in the TA of the terminal device after the terminal device completes the GNSS measurement, thereby effectively ensuring uplink transmission.

The terminal device executing the first operation in response to the terminal device initiating GNSS measurement may mean that, for example, the terminal device executes the first operation at the time when the terminal device initiates GNSS measurement. If the terminal device initiates GNSS measurement at time T, then the terminal device executing the first operation in response to the terminal device initiating GNSS measurement may also mean that the terminal device executes the first operation at a certain time after the time T or at a time of “time T+time duration n”. For another example, the terminal device executing the first operation in response to the terminal device initiating GNSS measurement can be replaced with the terminal device executing the first operation during executing GNSS measurement.

There are various methods to trigger the terminal device to initiate GNSS measurement. For example, GNSS measurement can be triggered by the terminal device or by the network device. In some embodiments, if a first condition is met, the terminal device initiates GNSS measurement. The aforementioned first condition may, for example, be associated with first information sent by the network device and/or a first timer.

The first information sent by the network device can be used to indicate to the terminal device to initiate GNSS measurement. The first information may be, for example, a GNSS measurement command issued by the network device to start the aforementioned GNSS measurement gap. Correspondingly, the first condition may include the terminal device receiving the first information sent by the network device.

A timing duration of the first timer is related to a validity duration of a result of the GNSS measurement of the terminal device. As mentioned above, the result of the GNSS measurement of the terminal device has a validity duration, and the terminal device can determine the validity duration of the result of the GNSS measurement according to a situation (such as a moving state) of the terminal device.

In some embodiments, the timing duration of the first timer may be the validity duration of the result of the GNSS measurement of the terminal device. In this way, the first condition can be set by using an existing timer that indicates validity of the result of the GNSS measurement, thereby facilitating implementation. In this case, the first condition may be expiration of the first timer, that is, the terminal device initiates GNSS measurement when the result of the GNSS measurement becomes invalid or when the validity duration of the result of the GNSS measurement expires. For another example, in some cases, within a certain period of time (within a time duration X) following expiration of the validity duration of the result of the GNSS measurement, the terminal device is allowed to use an expired GNSS position for time-frequency pre-compensation for uplink transmission. Therefore, the first condition may be after a first duration following the expiration of the first timer, that is, the terminal device initiates GNSS measurement after the first duration following the expiration of the validity duration of the result of the GNSS measurement.

In some embodiments, a dedicated first timer can be set for initiating GNSS measurement to facilitate separate control. For example, the timing duration of the first timer may be the validity duration of the result of the GNSS measurement of the terminal device. The first condition may be expiration of the first timer, that is, expiration of the first timer indicates to the terminal device to initiate GNSS measurement after expiration of the validity duration of the result of the GNSS measurement. For another example, the timing duration of the first timer may be the sum of the validity duration of the result of the GNSS measurement of the terminal device and the first duration. In this case, the first condition may be expiration of the first timer, that is, expiration of the first timer indicates to the terminal device to initiate GNSS measurement after the first duration following the expiration of the validity duration of the result of the GNSS measurement.

In the above two implementations, the first duration may be the aforementioned time duration X or a time duration associated with the time X.

In one case, with the first condition, the terminal device is controlled to initiate GNSS measurement when the validity duration of the result of the GNSS measurement expires, which can improve the validity of the result of the GNSS measurement. In another case, with the first condition, the terminal device is controlled to initiate GNSS measurement after the first duration following the expiration of the validity duration of the result of the GNSS measurement, which can enhance flexibility in determining the timing of GNSS measurement.

In some embodiments, the terminal device may receive second information sent by the network device. The second information can be used to indicate to the terminal device whether to execute the first operation when initiating GNSS measurement or during GNSS measurement. The first operation mentioned herein may refer to, for example, clearing or stopping using the dedicated offset parameter of the terminal device. That is to say, when the terminal device initiates GNSS or during GNSS measurement, whether to clear or stop using the dedicated offset parameter of the terminal device can be determined based on the indication from the network device, so as to improve system flexibility.

The dedicated offset parameter of the terminal device is essential for determining communication timing of the terminal device. In some embodiments, after the terminal device completes GNSS measurement and/or resumes communication transmission with the network device, if the terminal device receives a command or indication information carrying the dedicated offset parameter of the terminal device issued by the network device, the terminal device resumes using the dedicated offset parameter of the terminal device. The command or indication information carrying the dedicated offset parameter of the terminal device issued by the network device may be, for example, Differential Koffset MAC CE signaling issued by a base station. Then, after stopping using the dedicated offset parameter of the terminal device and before the terminal device receives the aforementioned indication information, the offset parameter used by the terminal device for uplink communication is the cell specific offset parameter.

In some embodiments, the terminal device is in an RRC_CONNECTED state. The terminal device in the RRC_CONNECTED state is usually unable to communicate during executing GNSS measurement, but the network device usually configures resources for the terminal device in the RRC_CONNECTED state. Therefore, when the terminal device in the RRC_CONNECTED state initiates GNSS measurement, the resource configured by the network device for the terminal device can be released to improve resource utilization. At the same time, using of the dedicated offset parameter of the terminal device is stopped, which helps avoid the impact on the uplink communication caused by an excessively small dedicated offset parameter of the terminal device.

In some embodiments, the dedicated offset parameter of the terminal device is carried in an MAC CE signaling.

In some embodiments, the aforementioned network device may be a network device in an NTN. That is, the method provided in the embodiments of the disclosure can be applied to NTN communication scenarios.

As mentioned above, the terminal device can perform uplink transmission based on the TA value to avoid issues such as intra-cell interference. Therefore, how to determine a reporting opportunity of the TA value of the terminal device becomes an issue that needs to be solved.

A wireless communication method is provided in another embodiment of the disclosure to solve the aforementioned issue. The wireless communication method provided in another embodiment of the disclosure is introduced below with reference to FIG. 8. The method illustrated in FIG. 8 may be applicable to any of the aforementioned communication scenarios. For example, the method illustrated in FIG. 8 may be applicable to an NTN network communication scenario, such as a scenario where NB-IoT and eMTC access NTN. For another example, the method illustrated in FIG. 8 may be applicable to an NR network communication scenario.

Reference can be made to FIG. 8. The wireless communication method may include step S810.

In step S810, when a second condition is met, a terminal device triggers reporting of a TA parameter. In other words, when the second condition is met, the terminal device reports the TA parameter. That is to say, the second condition is a trigger condition for the reporting of the TA parameter.

The aforementioned second condition is associated with one or more of: a time when the terminal device completes GNSS measurement, handover of a cell serving the terminal device, and handover of a satellite serving the terminal device.

As mentioned above, after the terminal device executes GNSS measurement, the TA of the terminal device may witness a significant change. Therefore, the second condition can be associated with a time when the terminal device completes the GNSS measurement, which helps to update the TA of the terminal device in a timely manner to reduce a TA error. In addition, when the GNSS measurement is completed, the terminal device can determine a parameter related to the TA based on a result of the GNSS measurement, such as the aforementioned N_{TA,UE-specific}, thereby facilitating the reporting of the TA parameter.

When the cell serving the terminal device is handed over, the TA parameter of the terminal device usually witness a significant change. Therefore, the second condition can be associated with the handover of the cell serving the terminal device. For example, the second condition may be a time for the handover of the cell serving of terminal device. That is, when the cell serving the terminal device is handed over, the terminal device triggers the reporting of the TA parameter.

According to the handover types of the cell serving the terminal device, the content of the aforementioned second condition can be determined. That is to say, a condition for the terminal device to trigger the reporting of the TA is associated with the cell handover type executed by the terminal device. As an implementation, the second condition may include one or more of: the terminal device receiving a cell handover command; when the terminal device initiates random access to a target cell; when the terminal device completes cell handover; and before the terminal device sends first uplink information to the target cell. The first uplink information is the earliest uplink information or PUSCH sent by the terminal device to the target cell.

The handover type of the serving cell includes at least RACH-less handover and cell switch. During the cell switch, the terminal device usually initiates the random access to the target cell, while during the RACH-less handover, the random access procedure is usually not included. Therefore, during the RACH-less handover, the second condition may include one or more of: the terminal device receiving the cell handover command; before the terminal device sends the first uplink information to the target cell; and when the terminal device completes the RACH-less cell handover. During the cell switch, the second condition may include one or more of: the terminal device receiving the cell handover command, such as a cell switch command MAC CE; when the terminal device initiates the random access to the target cell; before the terminal device sends the first uplink information to the target cell; and when the terminal device completes the cell switch.

In some cases, the satellite serving the terminal device has changed while a physical cell identifier (PCI) of the terminal device remains unchanged. For example, the satellite serving the terminal device switches from satellite 1 to satellite 2, but a ground station providing the service remains unchanged. Therefore, the second condition can also be associated with the handover of the satellite serving the terminal device. For example, the second condition may include that the satellite serving the terminal device is handed over while the PCI remains unchanged. Since the satellite serving the terminal device is handed over, the TA parameter of the terminal device usually witness a significant change. In this case, the terminal device triggers the reporting of the TA parameter, which helps to improve accuracy of the TA parameter.

In some embodiments, the second condition may include a first time. The first time may be associated with a time when satellite handover indication information sent by the network device is received, or the first time is a time indicated by the satellite handover indication information. Usually, the terminal device can acquire information about handover of the serving satellite through the satellite handover indication information satSwitchWithReSync broadcasted by the network device. That is to say, the satellite handover indication information sent by the network device may be, for example, the satellite handover indication information satSwitchWithReSync broadcasted by the network device.

For example, the first time may be the time when the satellite handover indication information is received, or the first time may be a time of “the time when the satellite handover indication information is received+a time duration Y”. For another example, the first time may be a time indicated in the received satellite handover indication information.

In some embodiments, the first time may be a time when the target cell starts to serve the terminal device. The time may be, for example, carried in the satellite handover indication information.

In some embodiments, when the second condition is met, the terminal device may determine whether to trigger the reporting of the TA parameter based on a first parameter configured by the network device. For example, the first parameter may be used to indicate to the terminal device whether to trigger the reporting of the TA parameter when any of the second conditions is met. For another example, the first parameter may be used to indicate to the terminal device whether to trigger the reporting of the TA parameter when one or some of the second conditions are met.

In other words, regarding different second conditions, the terminal device may determine whether to trigger the reporting of the TA parameter based on different parameters configured by the network device. In another example, the terminal device may determine whether to trigger the reporting of the TA parameter based on the same parameter configured by the network device.

As an example, when the first parameter can be used to indicate to the terminal device to trigger the reporting of the TA parameter when any of the aforementioned second conditions is met, that is, when one or more of the following are met: the terminal device receiving the cell handover command; when the terminal device initiates the random access to the target cell; when the terminal device completes the cell handover; and before the terminal device sends the first uplink information to the target cell. As another example, the first parameter may include a second parameter and a third parameter. The second parameter may be used to indicate to the terminal device to trigger the reporting of the TA parameter when the terminal device initiates the random access to the target cell. The third parameter may be used to indicate to the terminal device to trigger the reporting of the TA parameter when the terminal device receives the cell handover command.

In some embodiments, the first parameter is a TA reporting parameter, such as ta-Report, and/or a TA reporting configuration parameter, such as TAR-Config.

Taking the first parameter as ta-Report as an example, the first parameter may be used to indicate to the terminal device whether to trigger the reporting of the TA during the random access procedure. Taking the first parameter as TAR-Config as an example, the first parameter may be used to enable a terminal device in an RRC_CONNECTED state to report the TA.

In some embodiments, the first parameter is carried in a system message, and/or the first parameter is carried in a dedicated signaling of the terminal device. For example, when the first parameter is the TA reporting parameter, the first parameter may be carried in the system message. For another example, when the first parameter is the TA reporting configuration parameter, the first parameter may be carried in the dedicated signaling of the terminal device.

In some embodiments, the terminal device is in the RRC_CONNECTED state.

The embodiments of the disclosure introduce a TA reporting trigger-mechanism for multiple scenarios, which helps the network device to acquire the TA of the terminal device as early as possible in multiple scenarios. The multiple scenarios mentioned herein may include, for example, a scenario where the terminal device executes GNSS measurement. In the NTN communication network, if the network device acquires the TA of the terminal device in a timely manner, or as early as possible, the network device can be timely assisted in configuring the dedicated offset parameter of the terminal device, thereby helping to reduce delay of uplink transmission.

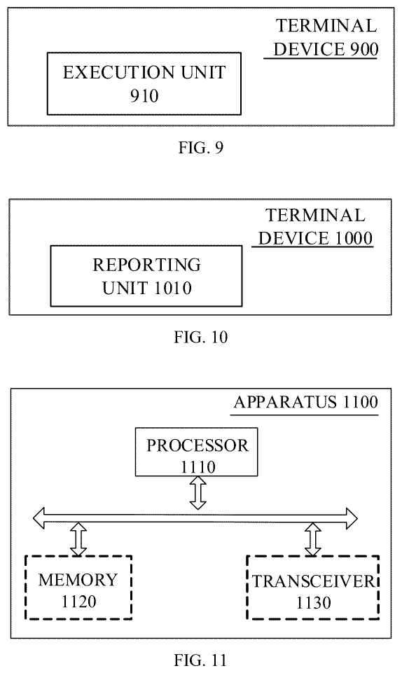

The above has described the method embodiments of the disclosure in detail with reference to FIG. 1 to FIG. 8, and the following will describe the apparatus embodiments of the disclosure in detail with reference to FIG. 9 to FIG. 11. It can be understood that the description of the method embodiments corresponds to the description of the apparatus embodiments. Therefore, for parts not described in detail, reference can be made to the above method embodiments.

FIG. 9 is a schematic diagram of a terminal device provided in an embodiment of the disclosure. The terminal device illustrated in FIG. 9 includes an execution unit 910.

The execution unit 910 is configured to cause the terminal device to execute a first operation, in response to the terminal device initiating global navigation satellite system (GNSS) measurement. The first operation includes one or more of: releasing a resource configured by a network device for the terminal device, and clearing or stopping using a dedicated offset parameter of the terminal device.

In some embodiments, the terminal device initiates the GNSS measurement as follows. The terminal device initiates the GNSS measurement when a first condition is met. The first condition is associated with one or more of: first information sent by the network device, where the first information is used to indicate to the terminal device to initiate the GNSS measurement; and a first timer, where a timing duration of the first timer is related to a validity duration of a result of the GNSS measurement of the terminal device.

In some embodiments, in response to the first condition is associated with the first timer, the first condition includes one or more of: expiration of the first timer, and after a first duration following expiration of the first timer.

In some embodiments, releasing the resource configured by the network device for the terminal device includes one or more of: clearing a hybrid automatic repeat request (HARQ) buffer of the terminal device, releasing a physical uplink control channel (PUCCH) resource of the terminal device, releasing a sounding reference signal (SRS) resource of the terminal device, releasing a dedicated resource of the terminal device for scheduling request (SR), releasing an uplink semi-persistent scheduling (SPS) resource of the terminal device, and releasing a downlink SPS resource of the terminal device.

In some embodiments, the dedicated offset parameter of the terminal device is a dedicated offset parameter of the terminal device indicated by the network device and received by the terminal device before initiating the GNSS.

In some embodiments, an offset parameter for uplink transmission of the terminal device is associated with a cell specific offset parameter and the dedicated offset parameter of the terminal device. Clearing or stopping using the dedicated offset parameter of the terminal device includes that the offset parameter for uplink transmission of the terminal device is the cell specific offset parameter.

In some embodiments, the first operation includes clearing or stopping using the dedicated offset parameter of the terminal device. The device further includes a receiving unit configured to receive second information sent by the network device. The second information is used to indicate to the terminal device whether to execute the first operation.

In some embodiments, the device further includes a processing unit. The processing unit is configured to cause the terminal device to resume using the dedicated offset parameter of the terminal device, in response to the terminal device receiving the dedicated offset parameter of the terminal device indicated by the network device, after the terminal device completes the GNSS measurement.

In some embodiments, the terminal device is in an RRC_CONNECTED state.

In some embodiments, the dedicated offset parameter of the terminal device is carried in a medium access control-control element (MAC CE) signaling.

In some embodiments, the network device is a network device in a non-terrestrial network (NTN).

FIG. 10 is a schematic diagram of a terminal device provided by another embodiment of the disclosure. The terminal device illustrated in FIG. 10 includes a reporting unit 1010.

The reporting unit 1010 is configured to cause a terminal device to trigger reporting of a timing advance (TA) parameter when a second condition is met. The second condition is associated with one or more of: a time when the terminal device completes global navigation satellite system (GNSS) measurement, handover of a cell serving the terminal device, and handover of a satellite serving the terminal device.

In some embodiments, the second condition is associated with the handover of the cell serving the terminal device. The second condition includes one or more of: the terminal device receiving a cell handover command; when the terminal device initiates random access to a target cell; when the terminal device completes cell handover; and before the terminal device sends first uplink information to the target cell. The first uplink information is the earliest uplink information sent by the terminal device to the target cell.

In some embodiments, the second condition is associated with the handover of the satellite serving the terminal device. The second condition includes a first time. The first time is associated with a time when satellite handover indication information sent by the network device is received, or the first time is a time indicated by the satellite handover indication information.

In some embodiments, the terminal device triggers the reporting of the TA parameter as follows. The terminal device determines whether to trigger the reporting of the TA parameter based on a first parameter configured by the network device.

In some embodiments, the first parameter is a TA reporting parameter and/or a TA reporting configuration parameter.

In some embodiments, the first parameter is carried in a system message, and/or the first parameter is carried in a dedicated signaling of the terminal device.

In some embodiments, the terminal device is in an RRC_CONNECTED state.

FIG. 11 is a schematic structural diagram of a communication apparatus according to embodiments of the disclosure. The dashed lines illustrated in FIG. 11 indicate that the unit or module is optional. The apparatus 1100 can be used to implement the method described in the above method embodiments. The apparatus 1100 may be a chip or a terminal device.

Apparatus 1100 may include one or more processors 1110. The processor 1110 can support the apparatus 1100 in implementing the methods described in the aforementioned method embodiments. The processor 1110 may be a general-purpose processor or a dedicated-purpose processor. For example, the processor may be a central processing unit (CPU). Alternatively, the processor may also be another general-purpose processor, a digital signal processor (DSP), an application specific integrated circuit (ASIC), a field programmable gate array (FPGA), or other programmable logic devices, discrete gates or transistor logic devices, discrete hardware components, etc. A general-purpose processor may be a microprocessor or may also be any conventional processor, etc.

Apparatus 1100 may further include one or more memories 1120. The memory 1120 is configured to store programs that can be executed by the processor 1110, to cause the processor 1110 to execute the methods described in the aforementioned method embodiments. The memory 1120 may be a separate device independent of the processor 1110 or may be integrated into the processor 1110.

Apparatus 1100 may further include a transceiver 1130. The processor 1110 can communicate with other devices or chips through the transceiver 1130. For example, the processor 1110 can transmit and receive data with other devices or chips through the transceiver 1130.

A computer-readable storage medium is further provided in embodiments of the disclosure. The computer-readable storage medium is configured to store programs. The computer-readable storage medium is applicable to the terminal device provided in embodiments of the disclosure, and the programs are operable with a computer to execute the method implemented by the terminal device in each embodiment of the disclosure.

A computer program product is further provided in embodiments of the disclosure. The computer program product includes programs. The computer program product is applicable to the terminal device provided in embodiments of the disclosure, and the programs are operable with a computer to execute the method implemented by the terminal device in each embodiment of the disclosure.

A computer program is further provided in embodiments of the disclosure. The computer program is applicable to the terminal device provided in embodiments of the disclosure, and the computer program is operable with a computer to execute the method implemented by the terminal device in each embodiment of the disclosure.

It can be understood that, the terms “system” and “network” herein are usually used interchangeably throughout this disclosure. In addition, the terms used in the disclosure are merely for explaining the specific embodiments of the disclosure, and are not intended to limit the disclosure. The terms “first”, “second”, “third”, “fourth” and the like used in description, claims and the accompanying drawings of the disclosure are used to distinguish different objects rather than to describe a particular order. In addition, the terms “include”, “comprise”, and “have” as well as variations thereof are intended to cover non-exclusive inclusion.

In embodiments of the disclosure, the referred “indication” may be a direct indication, may be an indirect indication, or may mean that there is an association relationship. For example, A indicates B may mean that A directly indicates B, for instance, B can be obtained according to A; may mean that A indirectly indicates B, for instance, A indicates C, and B can be obtained according to C; or may mean that that there is an association relationship between A and B.

In implementations of the disclosure, “B corresponding to A” indicates that B is associated with A, and B may be determined according to A. However, it should be further understood that, “determine B according to A” does not mean that B is determined according to A only, and B may also be determined according to A and/or other information.

In embodiments of the disclosure, the term “correspondence” may mean that there is a direct or indirect correspondence between the two, may mean that there is an association between the two, or may mean a relationship of indicating and indicated or configuring and configured, etc.

In embodiments of the disclosure, the “pre-defined” or the “pre-configured” can be implemented by pre-saving a corresponding code or table in a device (for example, including the terminal device and the network device) or in other manners that can be used for indicating related information, and the disclosure is not limited in this regard. For example, the “pre-defined” may mean defined in a protocol.

In embodiments of the disclosure, the “protocol” may refer to a communication standard protocol, which may include, for example, an LTE protocol, an NR protocol, and a protocol applied to a future communication system, and the disclosure is not limited in this regard.

In embodiments of the disclosure, the term “and/or” herein only describes an association relationship between associated objects, which means that there can be three relationships. For example, A and/or B can mean A alone, both A and B exist, and B alone. In addition, the character “/” herein generally indicates that the associated objects are in an “or” relationship.

In various embodiments of the disclosure, the magnitude of a sequence number of each of the foregoing processes does not imply an execution order, and the execution order between the processes should be determined according to function and internal logic thereof, which shall not constitute any limitation to the implementation of embodiments of the disclosure.

It will be appreciated that the system, the apparatuses and the methods disclosed in embodiments of the disclosure may also be implemented in various other manners. For example, the above apparatus embodiments are merely illustrative, e.g., the division of units is only a division of logical functions, and other manners of division may also be available in practice, e.g., multiple units or assemblies may be combined or may be integrated into another system, or some features may be ignored or omitted. In other respects, the coupling or direct coupling or communication connection as illustrated or discussed may be an indirect coupling or communication connection through some interface, device or unit, and may be electrical, mechanical, or otherwise.

Units illustrated as separated components may or may not be physically separated. Components displayed as units may or may not be physical units, and may reside at one location or may be distributed to multiple networked units. Some or all of the units may be selectively adopted according to practical needs to achieve desired objectives of the solutions of embodiments.

In addition, various functional units described in various embodiments of the disclosure may be integrated into one processing unit or may be present as a number of physically separated units, and two or more units may be integrated into one.

All or some of the above embodiments can be implemented through software, hardware, firmware, or any other combination thereof. When implemented by software, all or some the above embodiments can be implemented in the form of a computer program product. The computer program product includes one or more computer instructions. When the computer instructions are applied and executed on a computer, all or some the operations or functions of the embodiments of the disclosure are performed. The computer can be a general-purpose computer, a special-purpose computer, a computer network, or other programmable apparatuses. The computer instruction can be stored in a computer-readable storage medium, or transmitted from one computer-readable storage medium to another computer-readable storage medium. For example, the computer instruction can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer accessible usable-medium or a data storage device such as a server, a data center, or the like which integrates one or more usable media. The usable medium can be a magnetic medium (such as a soft disk, a hard disk, or a magnetic tape), an optical medium (such as a digital video disc (DVD)), or a semiconductor medium (such as a solid state disk (SSD)), etc.

The foregoing elaborations are merely implementations of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

What is claimed is:

1. A wireless communication method, comprising:
executing, by a terminal device, a first operation in response to the terminal device initiating global navigation satellite system (GNSS) measurement, wherein the first operation comprises one or more of:
releasing a resource configured by a network device for the terminal device; and
clearing or stopping using a dedicated offset parameter of the terminal device.

2. The method of claim 1, wherein the terminal device initiating the GNSS measurement comprises:
initiating, by the terminal device, the GNSS measurement when a first condition is met, wherein the first condition is associated with one or more of:
first information sent by the network device, wherein the first information is used to indicate to the terminal device to initiate the GNSS measurement; and
a first timer, wherein a timing duration of the first timer is related to a validity duration of a result of the GNSS measurement of the terminal device.

3. The method of claim 2, wherein in a case where the first condition is associated with the first timer, the first condition comprises one or more of:
expiration of the first timer; and
after a first duration following the expiration of the first timer.

4. The method of claim 1, wherein the dedicated offset parameter of the terminal device is a dedicated offset parameter of the terminal device indicated by the network device and received by the terminal device before initiating the GNSS.

5. The method of claim 1, wherein the terminal device is in a radio resource control (RRC) connected state.

6. The method of claim 1, wherein the dedicated offset parameter of the terminal device is carried in a medium access control-control element (MAC CE) signaling.

7. The method of claim 1, wherein the network device is a network device in a non-terrestrial network (NTN).

8. A wireless communication method, comprising:
triggering, by a terminal device, reporting of a timing advance (TA) parameter when a second condition is met, wherein the second condition is associated with one or more of:
a time when the terminal device completes global navigation satellite system (GNSS) measurement;
handover of a cell serving the terminal device; and
handover of a satellite serving the terminal device.

9. The method of claim 8, wherein the second condition is associated with the handover of the cell serving the terminal device, and the second condition comprises one or more of:
the terminal device receiving a cell handover command;
when the terminal device initiates random access to a target cell;
when the terminal device completes cell handover; and
before the terminal device sends first uplink information to the target cell,
wherein the first uplink information is an earliest uplink information sent by the terminal device to the target cell.

10. The method of claim 8, wherein triggering, by the terminal device, the reporting of a TA parameter comprises:
determining, by the terminal device, whether to trigger the reporting of the TA parameter based on a first parameter configured by a network device.

11. The method of claim 10, wherein the first parameter is a TA reporting parameter and/or a TA reporting configuration parameter.

12. The method of claim 10, wherein the first parameter is carried in a system message, and/or the first parameter is carried in a dedicated signaling of the terminal device.

13. The method of claim 8, wherein the terminal device is in a radio resource control (RRC) connected state.

14. A terminal device, comprising:
a memory and a processor;
wherein the memory is configured to store a computer program, which when executed by the processor, causes the terminal device to:
execute a first operation in response to the terminal device initiating global navigation satellite system (GNSS) measurement, wherein the first operation comprises one or more of:
releasing a resource configured by a network device for the terminal device; and
clearing or stopping using a dedicated offset parameter of the terminal device.

15. The terminal device of claim 14, wherein the terminal device initiating the GNSS measurement comprises:
initiating, by the terminal device, the GNSS measurement when a first condition is met, wherein the first condition is associated with one or more of:
first information sent by the network device, wherein the first information is used to indicate to the terminal device to initiate the GNSS measurement; and
a first timer, wherein a timing duration of the first timer is related to a validity duration of a result of the GNSS measurement of the terminal device.

16. The terminal device of claim 15, wherein when the first condition is associated with the first timer, the first condition comprises one or more of:
expiration of the first timer; and
after a first duration following the expiration of the first timer.

17. The terminal device of claim 14, wherein the dedicated offset parameter of the terminal device is a dedicated offset parameter of the terminal device indicated by the network device and received by the terminal device before initiating the GNSS.

18. The terminal device of claim 14, wherein the terminal device is in a radio resource control (RRC) connected state.

19. The terminal device of claim 14, wherein the dedicated offset parameter of the terminal device is carried in a medium access control-control element (MAC CE) signaling.

20. The terminal device of claim 14, wherein the network device is in a non-terrestrial network (NTN).
